(19) United States
(12) Patent Application Publication
(10) Pub. No.: US 2003/0033196 A1
(43) Pub. Date: Feb. 13, 2003

(54) Unintrusive targeted advertising on the world wide web using an entropy model

(76) Inventor: John Anthony Tomlin, Sunnyvale, CA (US)

Correspondence Address: PERMAN & GREEN, 425 POST ROAD, FAIRFIELD, CT, 06824, US

(21) Appl. No.: 09/860,857

(22) Filed: May 18, 2001

(51) Int. Cl. G06F 17/60

(52) U.S. Cl. 705/14

(57) ABSTRACT

A method for maximizing non-intrusive advertising revenue on the world wide web is provided. The method comprises the first step of obtaining an expected number of users, wherein the expected number of users is represented by Aᵢ (i=1 . . . m). The next step determines a number of available advertisements, wherein the number of available advertisements is represented by Bⱼ (j=1 . . . n) . Next is a determination a probability click through relationship between Aᵢ and Bⱼ; wherein the probability click through relationship is represented by wᵢⱼ. Lastly, these variables are incorporated into an entropy model which is then maximized for maximum revenue.

### BACKGROUND OF THE INVENTION

1. Field of the Invention

The present invention relates to advertising on the world wide web and, more particularly, to unintrusive targeted advertising using entropy models.

2. Brief Description of Related Developments

Many commercial World Wide Web (WWW) pages carry “banner Advertisements” (ads) which web users (“surfers”) may or may not choose to click on, depending on their interest in the advertisement. This invention provides models for maximizing the effectiveness of such banner ads, without engaging in intrusive data gathering on individual users, i.e., directly gathering a user's personal information.

The web advertising environment—the ad supply chain—can be characterized by three segments:

Advertisers who hire the agencies to display their ads as effectively as possible to users at the various properties;

Agencies/Brokerages who choose and display ads at a property, using what information there is available on the users (if any); and

The particular pages, also referred to as properties, typically at a portal, where banner ads are displayed by the agency/broker(s).

Agencies/brokers decide which advertisements (ads) to display to web users viewing particular pages at a property or properties, to maximize the total number of times that that users click on ads and so, through to advertisers' web site/sales pages.

For example, consider a group of users as those visiting a set of web pages (or groups of pages ) i=1 , . . . , m, during a typical fixed time period, with Aᵢ users in each group. This particular set of web pages is assumed to display banner ads that a single agency has contracted to show. Suppose the ads (or sets of similar ads) are grouped into “buckets” j=1 , . . . , n, each with Bⱼ ads available to be shown in this time period.

Let xᵢⱼ be the number of ads in group j shown to users in group i. This leads to the set of requirements shown in equation set (1):

$${\sum }_{j = 1}^{n} {x}_{ij} = {A}_{i} ( i = j , … m ) \\ {\sum }_{i = 1}^{m} {x}_{ij} = {B}_{j} ( j = 1 , … n ) \\ {x}_{i , j} \geq 0 ( i = 1 , … , m , j = 1 , … , n ) \qquad ( 1 )$$

and for feasibility, equation (2) must be satisfied:

$$X = {\sum }_{i = 1}^{m} {\sum }_{j = 1}^{n} {x}_{ij} = {\sum }_{i = 1}^{m} {A}_{i} = {\sum }_{j = 1}^{n} {B}_{j} \qquad ( 2 )$$

where X is the total number of ads shown. If the number of ads and users do not match, dummy users or ads may be introduced to enforce this balance.

Let cᵢⱼ be some expected payoff or profit derived by the agency for showing an ad in group j to a user in group i.

The objective is now to maximize the total payoff, or at least to reach some target. The simplest method of doing this is to simply:

$$Maximize {\sum }_{i = 1}^{m} {\sum }_{j = 1}^{n} {c}_{ij} {x}_{ij} \qquad ( 3 )$$

However, such a method produces unsatisfactory solutions, for theoretical reasons, because at most

m+n out of the possible mn ad-user pairs can have a nonzero xᵢⱼ value at the optimum. Such solutions are not only unacceptable in practice, but are liable to be unstable.

To illustrate what this means, consider a very simple example. Suppose there are 100 identical banner ads to be presented to two distinguishable types, or groups, of users, who view the page on which the ad may be displayed in equal numbers, and who have estimated click-through probabilities of 51% and 49%. A problem is, how many of the ads should be shown to each type of user to maximize the expected number of click-throughs? Letting x₁, x₂ represent the number of ads shown to users of type 1 and 2, this problem can be expressed as a linear program (LP):

Maximize 0.51x₁+0.49x₂

subject to x₁+x₂=100

xᵢ>=0

The obvious “optimal” solution is x₁=100, x₂=0. In other words, to show all the ads to the first group of users to achieve an expected 51 click-throughs. The second group is shown no ads at all. This solution is neither realistic nor desirable. Further, suppose the uncertainty in the click-through probabilities is a modest 5%. Then, in the worst case, the actual probabilities might be 46% and 54%, the coefficients in the function to be maximized would be 0.46 and the 0.54, rather than 0.51 and 0.49, respectively, and the “optimal” solution would be completely different—to show all of the ads to the second group of users (x₁=0, x₂=100) . This would result in 54 expected click-throughs, whereas our previous solution with x₁=100 would result in only 46. These drastic differences in solution are clearly unsatisfactory, and may be referred to as “all-or-nothing” solutions or “over-targeting” one group or another.

### SUMMARY OF THE INVENTION

In accordance with one embodiment of the present invention a method for maximizing non-intrusive advertising revenue on the world wide web is provided. The method comprises the first step of obtaining an expected number of users, wherein the expected number of users is represented by Aᵢ (i=1 . . . m). The next step determines a number of available advertisements, wherein the number of available advertisements is represented by Bⱼ (j=1 . . . n). Next is a determination of a probability click through relationship between Aᵢ and Bⱼ; wherein the probability click through relationship is represented by wᵢⱼ. Lastly, these variables are incorporated into an entropy model, which is then maximized for maximum revenue.

In accordance with another embodiment of the present invention a method for using a free energy function to maximize non-intrusive advertising revenue on the world wide web is provided. The method comprises the first step of obtaining an expected number of users, wherein the expected number of users is represented by Aᵢ (i=1 . . . m). The next step determines a number of available advertisements, wherein the number of available advertisements is represented by Bⱼ (j=1 . . . n). Next is a determination of a probability click through relationship between Aᵢ and Bⱼ; wherein the probability of a click through relationship is represented by wᵢⱼ. Lastly, these variables are incorporated into a first free energy function which is then maximized for maximum advertisement revenue.

### BRIEF DESCRIPTION OF THE DRAWINGS

The foregoing aspects and other features of the present invention are explained in the following description, taken in connection with the accompanying drawings, wherein:

FIG. 1 is a block diagram of one embodiment of a typical apparatus incorporating features of the present invention that may be used to practice the present invention; and

FIG. 2 is a flow chart of one method for dynamically presenting advertisements to a user in FIG. 1.

### DETAILED DESCRIPTION OF THE PREFERRED EMBODIMENT(S)

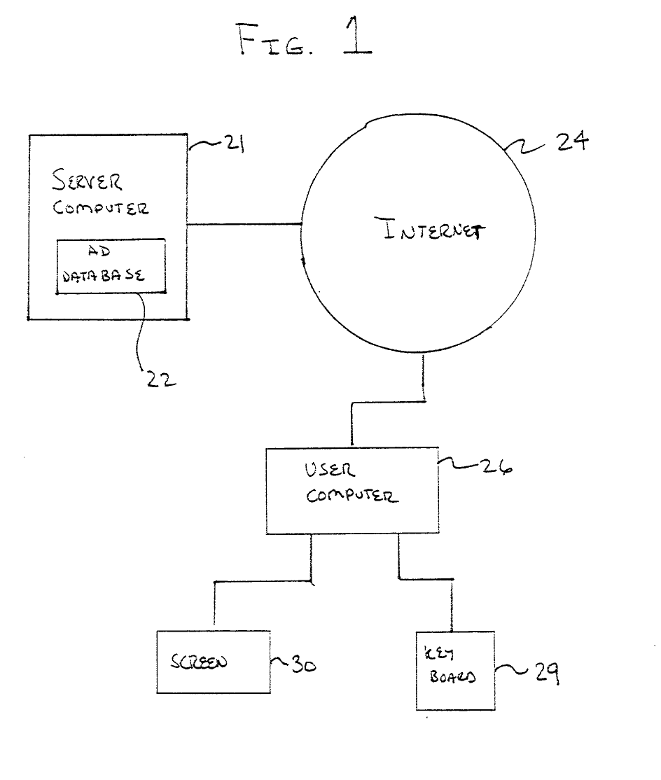

FIG. 1 is a block diagram of one embodiment of a typical apparatus incorporating features of the present invention that may be used to practice the present invention. As shown, a user computer system 26 may be linked to another server computer system 21, such that the computers 26 and 21 are capable of sending information to each other and receiving information from each other. In one embodiment, computer system 21 could include a server computer adapted to communicate with a network, such as for example, the Internet 24. Computer systems 21 and 26 can be linked together in any conventional manner including a modem, hard wire connection, or fiber optic link. Generally, information can be made available to both computer systems 21 and 26 using a communication protocol typically sent over a communication channel such as the Internet 24, or through a dial-up connection on ISDN line. Computers 21 and 26 are generally adapted to utilize program storage devices embodying machine readable program source code which is adapted to cause the computers 21 and 26 to perform the method steps of the present invention. The program storage devices incorporating features of the present invention may be devised, made and used as a component of a machine utilizing optics, magnetic properties and/or electronics to perform the procedures and methods of the present invention. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 21 and 26 may also include a microprocessor for executing stored programs. Computer 21 may include a data storage device 22 on its program storage device for the storage of information and data. The computer program or software incorporating the processes and method steps incorporating features of the present invention may be stored in one or more computers 21 and 26 on an otherwise conventional program storage device. In one embodiment, computers 21 and 26 may include a user interface 29, and a display interface 30 from which features of the present invention can be accessed. The user interface 29 and the display interface 30 can be adapted to allow the input of queries and commands to the system 40, as well as present the results of the commands and queries.

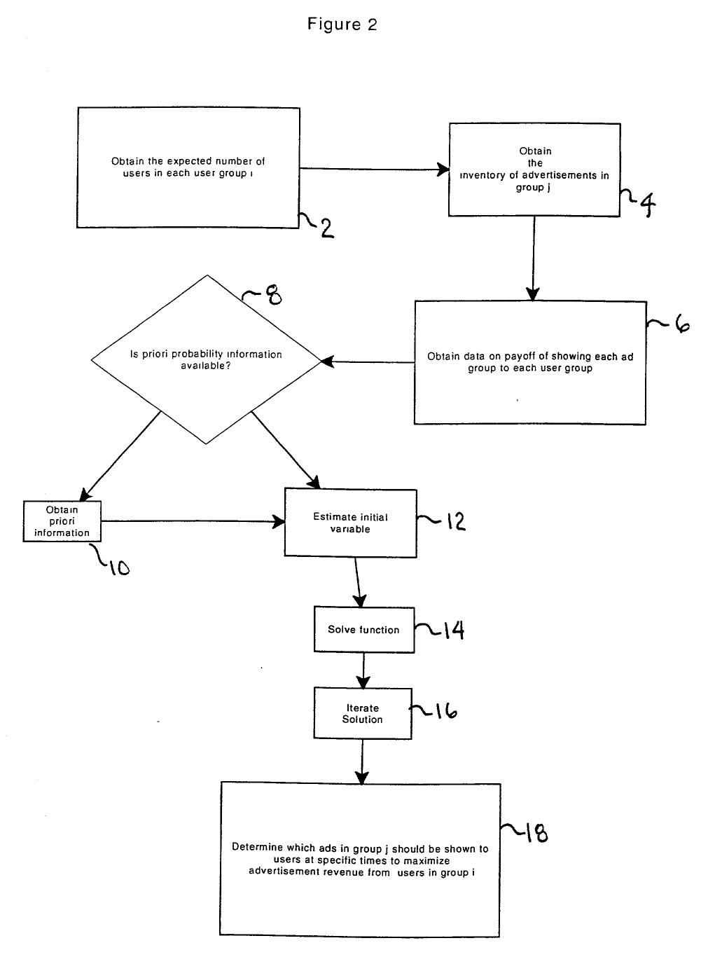

Referring now to FIG. 2, there is shown an embodiment of a method flow chart incorporating features of the present invention for maximizing advertising revenues. The method includes randomizing, as well as considering click-through probability, and is suitable for many types of users and ads. In one embodiment, a statistical argument is used in deriving this method. These models have the advantage that efficient algorithms are available for their solution, making them attractive in practice. With general regard to statistical models, reference can be had to “Equilibrium and Nonequilibrium Statistical Mechanics”, by R. Balescu, Wiley, N.Y. (1975) and “Statistical Thermodynamics” by E. Schrodinger, Dover Edition, Mineola, N.Y. (1989), the disclosure of both references are incorporated by reference in their entirety.

Still referring to FIG. 2, step 2 obtains the expected number of users in each group represented by the subscript i. The next step 4 obtains the inventory of advertisements in group j.

Step 6 obtains data on the desired payoff target C and is represented by:

$${\sum }_{i = 1}^{m} {\sum }_{j = 1}^{m} {c}_{ij} {x}_{ij} = C \qquad ( 4 )$$

and seek the “most probable” distribution of the xᵢⱼ which satisfies this constraint, and equations (1), (2).

Step 8 determines if priori probabilities wᵢⱼ for particular user-ad pairings (i,j) are known and obtains 10 these probabilities, then the joint probability of an outcome xᵢⱼ is:

$$P = \frac{X !}{{\prod }_{ij} {X}_{ij} !} {\prod }_{ij} {( {w}_{ij} )}^{{x}_{ij}} \qquad ( 5 )$$

Finding the maximum of P is equivalent of finding the maximum of the log of P, which after applying Stirling's approximation formula, and neglecting constant terms, requires:

$$Maximize {\sum }_{i = 1}^{m} {\sum }_{j = 1}^{n} [ ln ( {w}_{ij} ) {x}_{ij} - {x}_{ij} ln ( {x}_{ij} ) ] \qquad ( 6 )$$

subject to equations (1) and (4). The linear-logarithmic term appearing in equation (6) is an entropy function.

Assigning Lagrange multipliers λᵢ and μⱼ to the m+n equations (1), and estimating, step 12, the initial variable β and assigning it to equation (4), elementary calculus shows that the maximum is attained for values:

xᵢⱼ=wᵢⱼexp(λᵢ+μⱼ+βcᵢⱼ) (7)

Substituting this expression back into (1), the solutions to equation (7) can be expressed, step 14, in the functional form:

xᵢⱼ=aᵢAᵢbⱼBⱼwᵢⱼexp(βcᵢⱼ) (8)

where aᵢ and bⱼ are given by:

aᵢ=[ΣⱼbⱼBⱼw_{y}exp(βc_{y})]⁻¹ (i=1, . . . , m)

bⱼ=[ΣᵢaᵢAᵢw_{y}exp(βc_{y})]⁻¹ (j=1, . . . , n) (9)

In the preferred embodiment, efficient interactive (scaling) procedures are available for estimating the initial variable, step 12, which enables solving the problem, through iteration, step 16, without having to resort to more expensive general nonlinear programming methods. Step 18 then determine which ads in group j should be shown to users at specific times to maximize advertisement revenue from users in group i.

Note the intuitive nature of the solution: holding the other parameters constant, xᵢⱼ varies proportionally for small changes in Aᵢ and Bⱼ, and increases exponentially with the payoff value cᵢⱼ. Note also that since the model involves the logarithm of the xᵢⱼ's, they must necessarily be positive. Thus the difficulty of having too few non-zero user-ad pairings in the solution is avoided. Exogenous requirements for lower bounds on particular user-ad pairings (i.e. xᵢⱼ≧Lᵢⱼ) may be imposed by a simple change of variable ( as long as feasibility is not lost).

If the priori probabilities wᵢⱼ are not known, or are all equal, the wᵢⱼ terms may simply be omitted in the formulae (5)-(9). In an alternate embodiment the priori probabilities may be also include a relativity factor keyed to national or global events. For example, news coverage of golf champion Tiger Woods (i.e., wins another championship) could be sensed by server computer (FIG. 1, item 21). The relativity factor held in ad database (FIG. 1, item 22) is then increased for advertisements containing Tiger Woods ads in group j to be shown to users in group i.

In an alternative embodiment, a Helmholtz free-energy function, which is at a minimum for a system in equilibrium in conditions of constant volume and temperature may be used. This function is of the form:

F=E−K ln p (10)

where K is a constant, E is the internal energy, and p is the joint probability as defined in (5) Again using Stirling's formula, and defining

$${\overline{c}}_{ij} = [ {max {c}_{pq}}_{pq} ] - {c}_{ij} \qquad ( 11 )$$

and identifying these “non-payoff” values as the analogue of energy leads to:

$$F = constant + {\sum }_{i = 1}^{m} {\sum }_{j = 1}^{n} {x}_{ij} [ {\overline{c}}_{ij} + γ ( ln ( {x}_{ij} ) - ln ( {w}_{ij} ) ) ] \qquad ( 12 )$$

Here the initial variable γ is constant, replacing K, whose value is yet to be determined. We assert that the equilibrium distribution is that which minimizes F subject to (1). The constraint (4) is no longer needed, and the parameter γ accommodates a range of cases, from the extreme γ=0, which gives us the linear programming objective (3), to a completely proportional model, giving the solution

xᵢⱼ=AᵢBⱼ/X (13)

when γ is taken to be arbitrarily large. The general form of the solution to this model can be shown to be of form

ᵢⱼ=\acute{aᵢ}\acute{bⱼ}wᵢⱼexp(−\overline{cᵢⱼ}/γ) (14)

which is one of the same form as equation (8). Again, estimating an initial value for γ, step 8. It is known in other application (e.g. [8]) that under certain assumptions the weighted mean of the \overline{cᵢⱼ} provides a good fit and may be initially estimated here. This allows an iterative procedure (in γ) to solve the problem. A good initial value for γ has proved to be simply the mean of the \overline{cᵢⱼ} for some models, and sometimes this is even a good enough estimate to obtain good agreement between the model and real data. Once again the solution to (14) for any γ can be obtained by an efficient iterative (scaling) procedure, step 9. Note that close relationship between γ and the inverse of the multiplier β in the first formulation.

Thus far this form of the statistical model has been stated as a minimization problem. Once γ has been chosen this is of course equivalent to the maximization problem:

$$Maximize {\sum }_{i = 1}^{m} {\sum }_{j = 1}^{n} {x}_{ij} [ ( {c}_{ij} + γ ln ( {w}_{ij} ) ) - γ ln ( {x}_{ij} ) ] \qquad ( 15 )$$

subject to equation (1).

This form of the statistical model offers significant advantages over that stated in (1)-(6). The constraints are those of the classical transportation problem, and the rather arbitrary constraint (4) has been replaced by a parameter in the linear-logarithmic objective function for which we have some rationale for assigning a value. For either case, we have a self-contained, easily solvable, constrained optimization model that can be embedded in more complex models that may now consider building for the management of web advertising campaigns.

Note that we have made no assumptions on how the groups or “buckets” of users are defined. They may correspond to search keywords, states or histories. Similarly, the assigning of the ads to groups may be by individual or classes of ad. The key pieces of data are the number of users or ads in each bucket or group and the click-through probabilities. The question of maximizing revenue then naturally arises, and can be answered by applying revenue weights to the cᵢⱼ (payoff) terms in the objective.

The simple form of this invention may be embedded in larger models that go beyond the simple static one-agency model above. Different combinations of multiple advertisers, agencies, properties and classes of users are all enabled by the invention.

For concreteness, formulate a model which considers only the first two of these specifically—an agency and a number of advertisers who wish to present ads to users in (at least some of ) the same buckets. We also broaden the model to multiple time periods. The aim of the agency is to obtain ads from the advertisers that will maximize their net revenue, given the expected number of users in each bucket per time period, and the click-through probabilities for ads in each time period. For simplicity we omit the priori probabilities wᵢⱼ noting that they can be included in the objective function analogously with (15).

The components of this model are:

Indices

i=1 , . . . , m The buckets of users

j=1 , . . . , n The ad types available

k=1 , . . . , K The advertisers

t=1 , . . . , T Time periods

Data

Aᵢₜ The number of expected users in bucket i in period t.

cᵢⱼ Click-through probability for ad j by user i in period t.

Rᵢⱼₜ Revenue from click-through for ad j by user i in period t.

Dᵢⱼₜ Revenue (or Cost) for displaying ad j by user i in period t.

Pⱼₜ⁺ Penalty for shortfall of shown ads type j at end of period t.

Pⱼₜ⁻ Penalty for excess of shown ads type j at end of period t.

Mⱼₖₜ Agency's cost of obtaining ads of type j from advertiser k to be shown in period t.

Uⱼₖₜ Upper limit on ads of type j from advertiser k in period t.

Lⱼₖₜ Lower limit on ads of type j from advertiser k in period t.

γₜ Entropy weight for period t.

Variables

xᵢⱼₜ The displays of ad j for users type i in period t.

yⱼₖₜ The number of ads j bought by advertiser k for display in period t. _{z}ⱼₜ The number of ads j shown to all users in period t.

Sⱼₜ⁺ Inventory of un-shown ads of type j at end of period t.

Sⱼₜ⁻ Excess of shown ads of type j at end of period t

Constraints

Material Balance:

$${S}_{jt}^{+} - {S}_{jt}^{-} = {S}_{jt}^{+} - {S}_{jt}^{-} + {\sum }_{k = l}^{K} {y}_{jkt} - {z}_{jt} ∀ j , t \\ {\sum }_{j = 1}^{n} {z}_{jt} = {\sum }_{i = 1}^{m} {A}_{it} ∀ t \qquad ( 16 )$$

Supply and Demand:

$${\sum }_{j = 1}^{n} {x}_{ijt} = {A}_{it} ∀ i , t \\ {\sum }_{i = 1}^{m} {x}_{ijt} = {z}_{jt} ∀ j , t \qquad ( 17 )$$

Bounds:

Sⱼₜ⁺,Sⱼₜ⁻,xᵢⱼₜ,zⱼₜ≧0∀i,j,t (18)

Lᵢⱼₜ≦yᵢⱼₜ≦Uᵢⱼₜ∀i,j,t

Maximize

$${\sum }_{i , j , t} {x}_{ijt} ( {D}_{ijt} + {R}_{ijt} {c}_{ijt} - {γ}_{t} ln ( {x}_{ijt} ) ) - {\sum }_{jt} ( {P}_{jt}^{+} {s}_{jt}^{+} + {P}_{jt}^{-} {s}_{jt}^{-} ) - {\sum }_{jkt} {M}_{jkt} {y}_{jkt} \qquad ( 19 )$$

Note that by allowing revenues (or costs) to be associated with ads that are clicked on or otherwise (via the Dᵢⱼₜ and Rᵢⱼₜ coefficients), as well as marketing costs Mⱼₖₜ, considerable flexibility in the form of the objective is provided.

If we let H represent an m by n transportation problem coefficient matrix, the structure of the entire problem coefficient matrix is of the form:

$$[ \begin{matrix}{A}^{( 0 )} & & & & \\ {A}^{( 1 )} & H & & & \\ {A}^{( 2 )} & & H & & \\ ⋮ & & & ⋰ & \\ {A}^{( T )} & & & & H\end{matrix} ]$$

where the A^{(k)} are coefficients corresponding to the Yⱼₖₜ, zⱼₜ, Sⱼₜ⁺, Sⱼₜ⁻ variables only. This structure is well known in the optimization community to be amenable to a technique known as Generalization Benders Decomposition. Decomposition leads to multiple sub-problems of the form (1), (15) in only the Xᵢⱼₜ variables, with the right hand sides Bⱼₜ now determined by the “master” zⱼₜ values, and a “master” problem in the y, z, s⁺, s⁻ variables, with constraints derived from the A^{(k)} matrices and the “cuts” generated by the sub-problems. The overall solution procedure is very efficient, even for large problems.

It can be readily recognized that in alternate embodiments the Generalized Benders approach can be applied in a wider context. Any procedure for displaying groups of ads to buckets of users which can notionally be expressed as an optimization problem in the xᵢⱼₜ variables, subject to constraints only on those variables, is a candidate for this treatment.

There are many possible extensions to the embedded targeting model described above, to encompass more of the ad supply chain. It is relatively straightforward to extend it to consider properties on multiple portals by stratifying the buckets of users (say by adding an index p) and considering not only variables xₚᵢⱼₜ etc., but stratified revenues Rₚᵢⱼₖ etc. Such a model, incorporating agencies, advertisers and properties/portals will still have the basic matrix structure shown above, and be amenable to treatment by decomposition.

There are other statistical techniques, again grounded in transportation studies, which might well be considered for application in targeted advertising applications.

One of these is the “intervening opportunities” model which ranks, in this context, groups of ads in decreasing attractiveness for each bucket of users, and using a probability that opportunities of a certain rank will be passed up, constructs an exponential decay model for associating users with groups of ads.

It should be considered that the model(s) formulated here deliberately assume (since they are “unintrusive”) that very little is known about individual users—only the bucket to which they belong and the click-through probabilities for that bucket of users. If we relax the un-instrusivity requirement it may well be that we can stratify users by information level—some with the information level we have used above, some with limited information available through cookies, and others for which a detailed click-trail is available. Once again, it is possible to extend the model to accommodate this stratification, modifying it to vary the weight on the entropy terms for the different strata, without losing the matrix structure which promises efficient solution.

Other extensions of this model involve examining the structure of the costs which have thus far been considered constant. Especially when multiple advertisers and multiple portals are considered, there is an opportunity to use the model to evaluate some forms of nonlinear pricing for yield management.

The present invention may also include software and computer programs incorporating the method steps and instructions described above that are executed in different computers. In the preferred embodiment, the computers are connected to the Internet.

It should also be understood that the foregoing description is only illustrative of the invention. Various alternatives and modifications can be devised by those skilled in the art without departing from the invention. For example, there are many possible further extensions to the embedded targeting model described above, to encompass more of the ad supply chain. Such as extending the method to consider properties on multiple portals by stratifying the buckets of users say by adding an index p) and considering not only variables xₚᵢⱼₜ etc., but stratified revenues Rₚᵢⱼₖ etc. Such a model, incorporating agencies, advertisers and properties/portals will still have the basic matrix structure shown above, and be amenable to treatment by decomposition. Accordingly, the present invention is intended to embrace all such alternatives, modifications and variances which fall within the scope of the appended claims.

What is claimed is:

1. A method for maximizing non-intrusive advertising revenue on the world wide web, the method comprising the steps of:
obtaining an expected number of users, wherein the expected number of users is represented by
Aᵢ(i=1 . . . m);
determining a number of available advertisements, wherein the number of available advertisements is represented by
Bⱼ(j=1 . . . n);
determining a probability click through relationship between Aᵢ and Bⱼ; wherein the probability click through relationship is represented by
wᵢⱼ;
incorporating the probability click through relationship
wᵢⱼ; into a first mathematical entropy model; and
maximizing the first mathematical entropy model.

2. A method as in claim 1 wherein the step of obtaining an expected number of users comprises the step of:
capturing at least one characteristic from the group consisting of:
at least one spatial characteristic, wherein the at least one spatial characteristic comprises:
the group consisting of at least one keyword, at least one uniform resource library (URL), and at least one keyword and at least one URL;
at least one temporal characteristic; and
at least one spatial characteristic and at least one temporal characteristic, wherein the at least one spatial characteristic comprises:
the group consisting of at least one keyword, at least one uniform resource library (URL), and at least one keyword and at least one URL.

3. A method as in claim 1 wherein the step of incorporating the probability click through relationship into the first mathematical entropy model to maximize advertising revenue further comprises the step of maximizing the first mathematical entropy model, wherein the first mathematical entropy model comprises:
$${\sum }_{i = 1}^{m} {\sum }_{j = 1}^{n} [ ln ( wij ) xij - xij ln ( xij ) ]$$
where,
i=groups of users
j=groups of advertisements
xᵢⱼ=number of advertisements in group j shown to users in group i.
wᵢⱼ=a priori probabilities for user-advertisement pairings;
where the first mathematical entropy model is subject to the constraints:
$${\sum }_{j = 1}^{n} {x}_{ij} = {A}_{i} ( i = 1 … m )$$
$${\sum }_{i = 1}^{m} {x}_{ij} = {B}_{l} ( j = 1 … n )$$
$${\sum }_{i = 1}^{m} {\sum }_{j = 1}^{n} {c}_{ij} {x}_{ij} = C$$
where cᵢⱼ=expected return on investment for showing an advertisement in group j to a user in group i.

4. A method as in claim 3 wherein the step of maximizing the first mathematical entropy model further comprises the steps of:
assigning Lagrange multipliers λᵢ and μⱼ to m+n equations:
$${\sum }_{j = 1}^{n} {x}_{ij} = {A}_{i} ( i = 1 … m )$$
$${\sum }_{i = 1}^{m} {x}_{ij} = {B}_{j} ( j = 1 … n )$$
and assigning [symbol] to
$${\sum }_{i = 1}^{m} {\sum }_{j = 1}^{m} {c}_{ij} {x}_{ij} = C$$

5. A method as in claim 4 wherein the step of maximizing the first mathematical entropy model further comprises the steps of:
substituting the equation xᵢⱼ=wᵢⱼexp(λᵢ+μⱼ+βcᵢⱼ) into
$${\sum }_{j = 1}^{n} {x}_{ij} = {A}_{i} ( i = j , … m )$$
$${\sum }_{i = 1}^{m} {x}_{ij} = {B}_{j} ( j = 1 , … n )$$
x_{i,j}≧0(i=1, . . . , m, j=1, . . . , n)
arranging a solution into a form comprising:
xᵢⱼ=aᵢAᵢbⱼBⱼwᵢⱼexp(βcᵢⱼ)
where aᵢ and bⱼ are given by:
aᵢ=[ΣⱼbⱼBⱼwᵢⱼexp(βcᵢⱼ)]⁻¹(i=1, . . . m)
bⱼ=[ΣᵢaᵢAᵢwᵢⱼexp(βcᵢⱼ)]⁻¹(j=1, . . . n);
estimating the initial variable β; and
solving equation:
xᵢⱼ=aᵢAᵢbⱼBⱼwᵢⱼexp(βcᵢⱼ)

6. A method for maximizing non-intrusive advertising revenue on the world wide web, the method comprising the steps of:
obtaining an expected number of users, wherein the expected number of users is represented by
Aᵢ(i=1 . . . m);
determining a number of available advertisements, wherein the number of available advertisements is represented by
Bⱼ(j=1 . . . n);
determining a probability click through relationship between Aᵢ and d Bⱼ; wherein the probability click through relationship is represented by
wᵢⱼ;
incorporating the probability click through relationship wᵢⱼ; into a first free energy function; and
maximizing the first free energy function.

7. A method as in claim 6 wherein the step of obtaining an expected number of users comprises the step of:
capturing at least one characteristic from the group consisting of:
at least one spatial characteristic, wherein the at least one spatial characteristic comprises:
the group consisting of at least one keyword, at least one uniform resource library (URL), and at least one keyword and at least one URL;
at least one temporal characteristic; and
at least one spatial characteristic and at least one temporal characteristic, wherein the at least one spatial characteristic comprises:
the group consisting of at least one keyword, at least one uniform resource library (URL), and at least one keyword and at least one URL.

8. A method as in claim 5 wherein the step of incorporating the probability click through relationship into the first free energy function to maximize advertising revenue further comprises the step of maximizing the first free energy function, wherein the first free energy function comprises:
F=E−K ln P
where,
K=constant
E =internal energy
$$P = \frac{X !}{{Π}_{ij} {X}_{ij} !} {( {Π}_{ij} ( {w}_{ij} ) )}^{{x}_{ij}}$$

9. A method as in claim 8 wherein the step of maximizing the first mathematical entropy model further comprises the steps of:
applying Stirling's formula to the first free energy function;
$$\text{defining} {\overline{c}}_{ij} = [ {max {c}_{pq}}_{pq} ] - {c}_{ij}$$

10. A method as in claim 9 wherein the step of maximizing the first free energy function further comprises the steps of:
identifying at least one non-payoff value;
substituting the at least one non-payoff value to form:
$$F = constant + {\sum }_{i = 1}^{m} {\sum }_{j = 1}^{n} {x}_{ij} [ {\overline{c}}_{ij} + γ ( ln ( {x}_{ij} ) - ln ( {w}_{ij} ) ) ]$$

11. A method as in claim 10 where in the step of maximizing the first free energy function further comprises the steps of:
obtaining at least one first solution, the at least one first solution comprising the form:
xᵢⱼ=AᵢBⱼ/X
obtaining at least one second solution to the at least one first solution, the at least one second solution comprising a first form:
xᵢⱼ=áᵢ\acute{b}ⱼwᵢⱼexp(−\overline{c}ᵢⱼ/γ);
estimating the initial variable γ; and
solving the first form.

12. A computer program product comprising:
a computer useable medium having computer readable code means embodied therein for causing a computer to maximize non-intrusive advertising revenue on the world wide web, the computer readable code means in the computer program product comprising:
computer readable program code means for causing a computer to obtain an expected number of users, wherein the expected number of users is represented by Aᵢ (i=1 . . . m);
computer readable program code means for causing a computer to determine a number of available advertisements, wherein the number of available advertisements is represented by Bⱼ (j=1 . . . n);
computer readable program code means for causing a computer to determine a probability click through relationship between Aᵢ and Bⱼ; wherein the probability click through relationship is represented by wᵢⱼ;
computer readable program code means for causing a computer to incorporate the probability click through relationship wᵢⱼ into a first mathematical entropy model; and
computer readable program code means for causing a computer to maximize the first mathematical entropy model.

13. The computer product of claim 12 further comprising computer readable program code means for causing a computer to obtain an expected number of users by capturing at least one characteristic from the group consisting of at least one spatial characteristic, wherein the at least one spatial characteristic comprises:
the group consisting of at least one keyword, at least one uniform resource library (URL), and at least one keyword and at least one URL;
at least one temporal characteristic; and
at least one spatial characteristic and at least one temporal characteristic, wherein the at least one spatial characteristic comprises:
the group consisting of at least one keyword, at least one uniform resource library (URL), and at least one keyword and at least one URL.

14. The computer product of claim 12 further comprising computer readable program code means for causing a computer to incorporate the probability click through relationship into the first mathematical entropy model to maximize advertising revenue further by maximizing the first mathematical entropy model, wherein the first mathematical entropy model comprises:
$${\sum }_{i = 1}^{m} {\sum }_{j = 1}^{n} [ ln ( wij ) xij - xij ln ( xij ) ]$$
where,
i=groups of users;
j=groups of advertisements;
xᵢⱼ=number of advertisements in group j shown to users in group i;
wᵢⱼ=a priori probabilities for user-advertisement pairings; and
where the first mathematical entropy model is subject to the constraints:
$${\sum }_{j = 1}^{n} {x}_{ij} = {A}_{i} ( i = 1 … m )$$
$${\sum }_{i = 1}^{m} {x}_{ij} = {B}_{j} ( j = 1 … n )$$
$${\sum }_{i = 1}^{m} {\sum }_{j = 1}^{n} {c}_{ij} {x}_{ij} = C$$
where cᵢⱼ=expected return on investment for showing an advertisement in group j to a user in group i.

15. The computer program product of claim 14 further comprising computer readable program code means for causing a computer to maximize the first mathematical entropy model further by assigning Lagrange multipliers λᵢ and μⱼ to m+n equations:
$${\sum }_{j = 1}^{n} {x}_{ij} = {A}_{i} ( i = 1 … m )$$
$${\sum }_{i = 1}^{m} {x}_{ij} = {B}_{j} ( j = 1 … n )$$
and assigning to
$${\sum }_{i = 1}^{m} {\sum }_{j = 1}^{m} {c}_{ij} {x}_{ij} = C$$

16. The computer program product of claim 15 further comprising computer readable program code means for causing a computer to maximize the first mathematical entropy model by substituting the equation
xᵢⱼ=wᵢⱼexp(λᵢ+μⱼ+βcᵢⱼ)
into:
$${\sum }_{j = 1}^{n} {x}_{ij} = {A}_{i} ( i = j , … m )$$
$${\sum }_{i = 1}^{m} {x}_{ij} = {B}_{j} ( j = 1 , … n )$$
$${}^{x} i , j \geq 0 ( i = 1 , … , m , j = 1 , … , n )$$
arranging a solution into a form comprising:
xᵢⱼ=aᵢAᵢbⱼBⱼwᵢⱼexp(βcᵢⱼ)
where a_{I}, and bⱼ are given by:
$$\begin{matrix}{a}_{i} = {[ {\sum }_{j} {b}_{j} {B}_{j} {w}_{ij} exp ( β {c}_{ij} ) ]}^{- 1} ( i = 1 , … , m ) \\ {b}_{j} = {[ {\sum }_{i} {a}_{i} {A}_{i} {w}_{ij} exp ( β {c}_{ij} ) ]}^{- 1} ( j = 1 , … , n ) ;\end{matrix}$$
estimating the initial variable β; and
solving the equation
xᵢⱼ=aᵢAᵢbⱼBⱼwᵢⱼexp (βcᵢⱼ)

17. An article of manufacture comprising:
a computer useable medium having computer readable code means embodied therein for causing a computer to maximize non-intrusive advertising revenue on the world wide web, the computer readable code means in the computer program product comprising:
computer readable program code means for causing a computer to obtain an expected number of users, wherein the expected number of users is represented by Aᵢ (i=1 . . . m);
computer readable program code means for causing a computer to determine a number of available advertisements, wherein the number of available advertisements is represented by Bⱼ (j=1 . . . n);
computer readable program code means for causing a computer to determine a probability click through relationship between Aᵢ and Bⱼ; wherein the probability click through relationship is represented by wᵢⱼ;
computer readable program code means for causing a computer to incorporate the probability click through relationship wᵢⱼ into a first mathematical entropy model; and
computer readable program code means for causing a computer to maximize the first mathematical entropy model.

18. The article of manufacture of claim 17 further comprising computer readable program code means for causing a computer to obtain an expected number of users by capturing at least one characteristic from the group consisting of at least one spatial characteristic, wherein the at least one spatial characteristic comprises:
the group consisting of at least one keyword, at least one uniform resource library (URL), and at least one keyword and at least one URL;
at least one temporal characteristic; and
at least one spatial characteristic and at least one temporal characteristic, wherein the at least one spatial characteristic comprises:
the group consisting of at least one keyword, at least one uniform resource library (URL), and at least one keyword and at least one URL.

19. The article of manufacture of claim 17 further comprising computer readable program code means for causing a computer to incorporate the probability click through relationship into the first mathematical entropy model to maximize advertising revenue further by maximizing the first mathematical entropy model, wherein the first mathematical entropy model comprises:
$${\sum }_{i = 1}^{m} {\sum }_{j = 1}^{n} [ ln ( wij ) xij - xij ln ( xij ) ]$$
where,
i=groups of users;
j=groups of advertisements;
xᵢⱼ=number of advertisements in group j shown to users in group i;
wᵢⱼ=a priori probabilities for user-advertisement pairings; and
where the first mathematical entropy model is subject to the constraints:
$${\sum }_{j = 1}^{n} {x}_{ij} = {A}_{i} ( i = 1 … m )$$
$${\sum }_{i = 1}^{m} {x}_{ij} = {B}_{j} ( j = 1 … n )$$
$${\sum }_{i = 1}^{m} {\sum }_{j = 1}^{n} {c}_{ij} {x}_{ij} = C$$
where cᵢⱼ=expected return on investment for showing an advertisement in group j to a user in group i.

20. The article of manufacture of claim 17 further comprising computer readable program code means for causing a computer to maximize the first mathematical entropy model by substituting the equation
xᵢⱼ=wᵢⱼexp(λᵢ+μⱼ+βcᵢⱼ)
into:
$${\sum }_{j = 1}^{n} {x}_{ij} = {A}_{i} ( i = j , … m )$$
$${\sum }_{i = 1}^{m} {x}_{ij} = {B}_{j} ( j = 1 , … n )$$
$${}^{x} i , j \geq 0 ( i = 1 , … , m , j = 1 , … , n )$$
arranging a solution into a form comprising:
xᵢⱼ=aᵢAᵢbⱼBⱼwᵢⱼexp(βcᵢⱼ)
where a_{I} and bⱼ are given by:
aᵢ=[ΣⱼbⱼBⱼwᵢⱼexp(βcᵢⱼ)]⁻¹(i=1, . . . , m)
bⱼ=[ΣᵢaᵢAᵢwᵢⱼexp(βcᵢⱼ)]⁻¹ (j=1, . . . , n)
estimating the initial variable β; and
solving the equation
xᵢⱼ=aᵢAᵢbⱼBⱼwᵢⱼexp(βcᵢⱼ)
